(19) United States
(12) Patent Application Publication
(10) Pub. No.: US 2002/0013155 A1
(43) Pub. Date: Jan. 31, 2002

(54) Mobile communications device data sharing system and method

(76) Inventors: Shirish N. Jamthe, Burlington, MA (US); Jeffrey A. Foust, Waltham, MA (US)

Correspondence Address: Iandiorio & Teska, 260 Bear Hill Road, Waltham, MA, 02451-1018, US

(21) Appl. No.: 09/746,606

(22) Filed: Dec. 21, 2000

Related U.S. Application Data
(60) Provisional application No. 60/213,628, filed on Jun. 23, 2000.

(51) Int. Cl. H04B 7/00; H04Q 7/20

(52) U.S. Cl. 455/517; 455/412; 455/418

(57) ABSTRACT

A system for sharing data with users of mobile communications devices, such as personal data assistants (PDAs) or cellular phones, is provided, including a data selection system, a field filtering system, identifier entry and validation systems, a data retrieval system, and a local storage system.

### RELATED APPLICATIONS

This application claims benefit of U.S. Provisional Application 60/213,628, filed on Jun. 23, 2000, entitled “Device to Device Communications Method and Technology.” This invention is also related to U.S. Patent Application No. 09/536,500, filed on Mar. 27, 2000, entitled “Personal Data Assistant Intemet-Based Data Retrieval and Organization System and Method” which is incorporated herein by reference.

### FIELD OF THE INVENTION

This invention relates to a system and method for sharing data with mobile communications devices, such as personal data assistants (PDAs) and cellular phones.

### BACKGROUND OF THE INVENTION

Mobile communications devices, such as personal data assistants (PDAs) and cellular telephones, have grown in popularity over recent years. These devices allow users to share information through such techniques as email and instantaneous messaging which allows users to send and receive message alerts to each other.

However, users of these devices have found it difficult to share information with other people. What has not been available is a system or method through which data can be easily shared directly into the appropriate applications of a receiving device.

Prior methods have allowed one user to select information, incorporate that information into an email or instantaneous message, and send that email or instantaneous message to one or more recipients who must then read the content and manually transfer the information into the appropriate application or applications on their own mobile communications device.

### BRIEF SUMMARY OF THE INVENTION

It is therefore an object of this invention to provide a system and method for data sharing of information among users of mobile communications devices.

It is a further object of this invention to provide such a system and method for sharing information in which the information is shared by use of at least one intermediate hub which stores and routes the information to the receiving users and places the information inside applications of the receiving mobile communications devices.

It is a further object of this invention to provide such a system and method through which users can create a trusted community of other users with whom to share information and to give the recipients of such shared information control over accepting or rejecting such information transfers.

This invention results from the realization that more effective and efficient sharing of information can be achieved by providing a system and method for utilizing at least one intermediate hub for storing and routing such shared data such that the shared data is actually inserted into the appropriate applications of the receiving mobile communications devices. This data sharing may be done across disparate devices and networks, whether they be wired or wireless.

The present invention provides a mobile communications device data sharing system including a data field and storage system for storing data in a plurality of discrete data elements and a data selection system for selecting at least one of the discrete data elements to be shared. Also included is a data selection system, identifier entry and validation systems, a data retrieval system, and a local storage system. The data selection system may be manual or automatic and may be voice activated.

The present invention also provides a method for mobile communications device data sharing including the steps of selecting at least one data segment from a data source, filtering the data segment into at least one discrete data field element, and entering and validating recipient identifier information. The method further includes the steps of storing remotely the discrete data field element on at least one intermediate server, downloading the discrete data field element and storing the discrete data field element within the mobile communications device. The step of storing remotely the discrete data field element may further include formatting the discrete data field element for storage in at least one specified data field of the mobile communications device. The step of validating recipient identifier information may further include determining that the format of the identifier is proper and that the recipient identified is a valid user. If the recipient identified is not a valid user, the method may further include the steps of offering the non-valid user the option of registering as a valid user and receiving the non-valid user's registration information.

### BRIEF DESCRIPTION OF THE DRAWINGS

Other objects, features and advantages will occur to those skilled in the art from the following description of a preferred embodiment and the accompanying drawings, in which:

FIG. 1 is a diagrammatic view of a mobile communications device data sharing system according to this invention;

FIG. 2 is a flow chart of a method for sharing data among users of mobile communications devices according to this invention; and

FIG. 3 is a flow chart of the recipient identifier step of the method of FIG. 2.

### PREFERRED EMBODIMENT

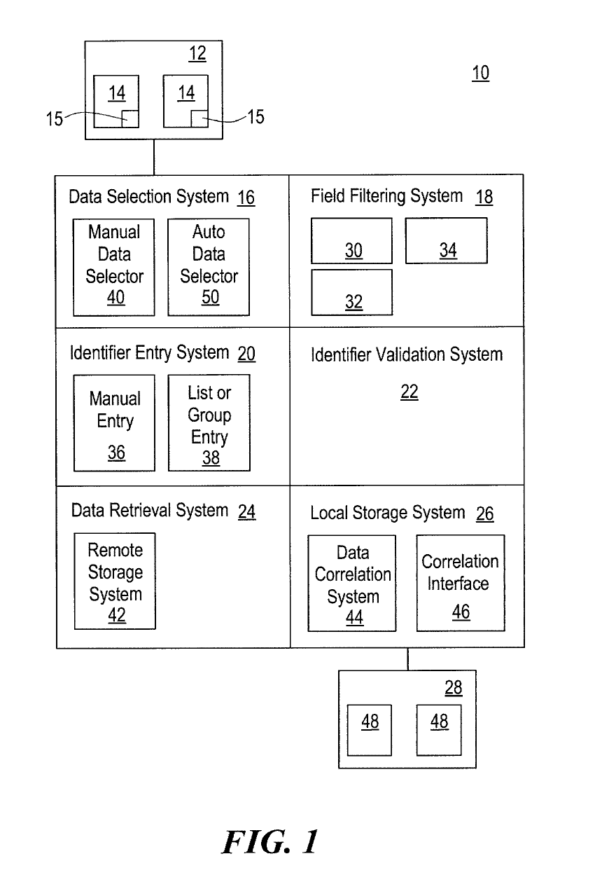

One embodiment of the system 10 of the present invention is shown in FIG. 1. The information to be shared is shown as data source 12. Data source 12 may be, for example, a web page, desktop or mobile device applications, email, Internet browser application or intranet applications. Within data source 12 there may be one or more data segments 14 which are of interest to a user of a mobile communications device 28. System 10 consists generally of data selection system 16, field filtering system 18, identifier entry system 20, identifier validation system 22, data retrieval system 24, and local storage system 26.

System 10 allows a user to easily select some or all data from a data source to be shared with other users. The addresses of those users who are to receive the data are entered by the sender and then validated by system 10. Recipients may either allow data from specific senders to be automatically downloaded to their mobile communications devices or require a manual transfer request for the data transfer to occur.

Data selection system 16 allows the user to select the desired data segments 14 from data source 12. Data selection system 16 may include a manual data selector 40 which enables a user of system 10 to manually select data segments 14 from data source 12. Manual data selector 40 can include an audio portion 50, to enable the user to select data using voice commands. Manual data selector 40 can also enable the user to select data segments 14 by using a mouse to click on the data or by selecting, dragging and dropping the data into a predefined location. Data selection system 16 may include automatic data selector 50 which would provide for automatically selecting data using an automated job or script, for example, a common gateway interface (CGI) call to send specific information out to selected recipients.

Filtering system 18 includes a field tag identifier 30 for locating field identification tags 15 within the selected data segments 14 selected by the data selection system 16. These field identification tags 15, which may be XML tags, are programmed into the data segments 14 by the host of the data source in order to enable the specific data segments 14 selected by the data selection system 16 to be identified as either an address, a phone number, an event or any other type of data. Field filtering system 18 also includes a data format recognition system 32 for comparing the specific data segments 14 selected by the data selection system 16 with predefined data types in order to identify the types of data selected. A data parser 34 is responsive to the data format recognition system 32 for parsing the specific data segments 14 into a plurality of discrete data field elements 35.

Identifier entry system 20 includes manual entry system 36 through which a user can manually specify the address or addresses of the recipients of the discrete data field elements 35. Identifier entry system 20 may also include list (or group) entry system 38 through which a user may select a list of recipients to receive discrete data field elements 35. Identifier entry system 20 may include some users' preset profiles or there may be some integration between identifier entry system 20 and external applications such as Lotus Notes® or LDAP server.

Identifier validation system 22 verifies that the address or addresses entered through identifier entry system 20 are valid. A recipient may also specify whether data from particular users or particular types of data is to be automatically transferred to the recipient's mobile communications device 28 or if manual approval of such transfer by the recipient is required before the transfer may be completed.

Data retrieval system 24 includes a remote storage system 42, which typically is a server device for storing either specific data segments 14 selected by data selection system 16 or discrete data field elements 35 from field filtering system 18. Remote storage system 42 may also convert the data based on the format of data to be stored by local storage system 26.

Local storage system 26 includes a data correlation system 44 for relating the discrete data field elements 35 identified by the field filtering system 18 to a specified data field 48 of mobile communications device 28. A correlation interface 46 operates to specify individual relationships between each of the discrete data field elements 35 and each of the specified data fields 42 within mobile communications device 28.

If mobile communications device 28 is Internet capable, such as the Palm VII® from 3Com®, the discrete data field elements 35 are transferred directly to the local storage system 26 for storage on mobile communications device 28.

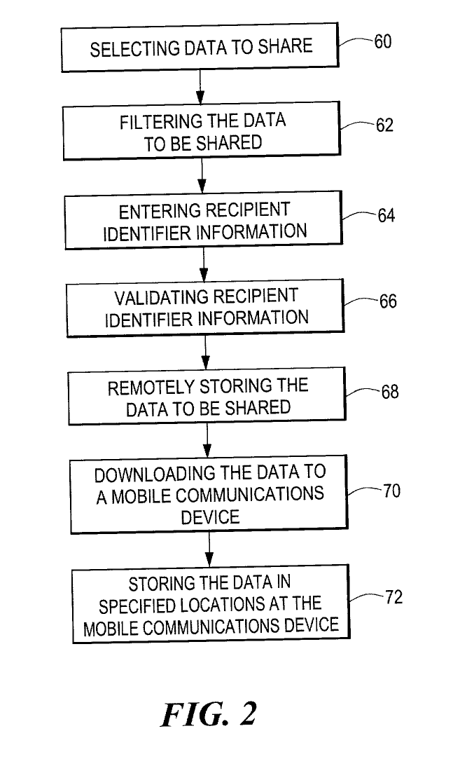

Another embodiment of this invention is the method for mobile communications device data sharing, FIG. 2, which includes the steps of: selecting specific data segments from a data source to be downloaded into a mobile communications device, 60; filtering the specific data segments into a plurality of discrete data field elements, 62; entering recipient identifier information, 64; validating recipient identifier information, 66; remotely storing the plurality of discrete data fields elements on, for example, an intermediate server, 68; downloading the plurality of discrete data field elements to the mobile communications device, 70; and storing the plurality of discrete data field elements are stored in at least one specified data field within the mobile communications device, 72.

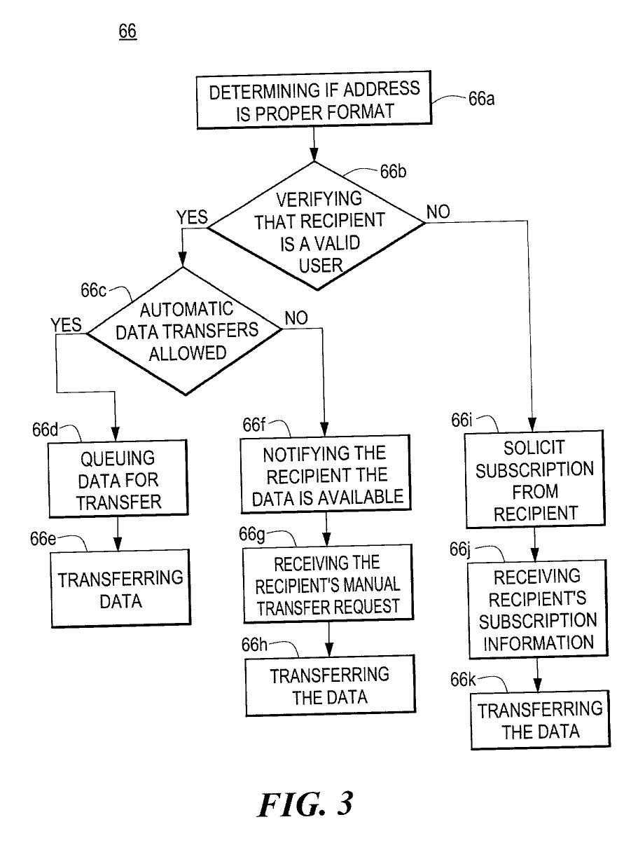

Validating recipient identifier information, 66 of FIG. 2, may include the following steps, as shown in the flowchart of FIG. 3: determining if the recipient identifier information is a proper format for communication, 66a; and verifying that the recipient is a valid user, 66b. If the recipient is a valid user, the next step is determining if the recipient has allowed automatic transfers from the sender, 66c; queuing the data to be shared at the next sync request from the recipient, 66d; and transferring the data, 66e.

If the recipient is a valid user but has not specified the sender as one from which to automatically receive shared data, the next step is notifying the recipient that the data is available, 66f; receiving a manual transfer request from the recipient; 66g; and transferring the data, 66h.

If the recipient is not a valid user, the next step is offering the recipient the option to subscribe to the hosting company's services, 66i; receiving the recipient's subscription information, 66j; and transferring the data, 66k.

In operation, a user selects data to share with others and enters the addresses of those recipients. The system of the present invention then verifies the recipient addresses and either automatically, or upon confirming request from the recipients, depending upon how the recipients have set their preferences for receiving such shared data, transfers the data to the recipients' mobile communications devices.

It should be appreciated that these are only a few embodiments of the specific invention and that this invention and method could be constructed using any combination of hardware/firmware components and software-based algorithms.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A mobile communications device data sharing system for sharing data with a mobile communications device comprising:
a data field filtering and storage system for storing data into a plurality of discrete data elements;
a data selection system for selecting at least one of said plurality of discrete data elements to create a shared data package;
an identifier entry system for entering at least one identifier of a recipient;
an identifier validation system for validating said at least one identifier;
a data retrieval system, responsive to said data field and storage system, said data selection system and said identifier validation system, for transferring said shared data package to the recipient; and
a local storage system for storing said shared data package at the mobile communication device.

2. The system of claim 1 wherein said data selection system includes an automated data selector for automatically selecting said at least one of said plurality of discrete data elements.

3. The system of claim 1 wherein said data selection system includes a manual data selector for enabling a user to manually select said at least one of said plurality of discrete data elements.

4. The mobile communications device data sharing system of claim 1 wherein said data selection systems includes a voice-activated data selector.

5. A method for mobile communications device data sharing, comprising the steps of:
selecting at least one data segment from a data source;
filtering the at least one data segment into at least one discrete data field element;
entering recipient identifier information;
validating recipient identifier information;
storing remotely the at least one discrete data field element on at least one intermediate server;
downloading the at least one discrete data field element to a mobile communications device; and
storing the at least one discrete data field element in at least one specified data field within the mobile communications device.

6. The method for mobile communications device data sharing of claim 5, wherein said step of storing remotely the at least one discrete data field element further comprises formatting said at least one discrete data field element for storage in at least one specified data field within the mobile communications device.

7. The method for mobile communications device data sharing of claim 5, wherein said step of validating recipient identifier information further comprises determining that the recipient identifier information is in a proper format and determining that the recipient identifier information identifies a valid user.

8. The method for mobile communications device data sharing of claim 7, wherein said step of deteminining that the recipient identifier information identifies a valid user further comprises offering a non-valid user an option to register as a valid user and receiving the non-valid user's registration information.
